(19) United States
(12) Patent Application Publication
(10) Pub. No.: US 2024/0384053 A1
(43) Pub. Date: Nov. 21, 2024

(54) METHOD OF MAKING A HEMP FIBER FOAM

(71) Applicant: Hemp Foam LLC, Katy, TX (US)

(72) Inventors: Brandon Bain, Katy, TX (US); Brandon Jamison, Pontotoc, MS (US)

(73) Assignee: Hemp Foam LLC, Katy, TX (US)

(21) Appl. No.: 18/319,112

(22) Filed: May 17, 2023

(51) Int. Cl. C08J 9/00; B68G 7/00

(52) U.S. Cl. CPC C08J 9/0085; B68G 7/00; C08J 2203/10; C08J 2399/00

(57) ABSTRACT

A method of producing a hemp fiber foam is disclosed. The method may include providing a mixture of foam reactants including an amount of hemp fiber that contains an amount of absorbed moisture. The method may further include providing an amount of water to the mixture based on the amount of absorbed moisture within the amount of hemp fiber. The method may further include reacting the mixture, pouring the mixture into a mold, and curing the mixture to form a hemp fiber foam wherein the amount of hemp fiber is incorporated into the hemp fiber foam.

### TECHNICAL FIELD

The present disclosure relates generally to a method for producing hemp fiber foam with more sustainable materials in a more efficient manner, while maintaining highly desired performance and feel of the product and eliminating offensive odors associated with foam. More particularly, the present disclosure provides a method for producing a hemp fiber foam bedding material that exhibits improved performance and feel while reducing use of petrochemicals.

### BACKGROUND

Foams have been used as a bedding material since the mid-20^{th} century, and foam mattresses have since become highly desired by consumers. The most common types of foam mattresses currently sought on the market include latex foam and polyurethane foam mattresses. A latex foam mattress provides constant support and does not get softer when exposed to a warmer environment. Further, latex may make it easier to move around during the night with minimal exertion and provide a cooling effect, and thus minimize disruptions to sleep. Latex may be synthesized without using any petrochemicals, and thus is highly desirable as an “all-natural” product that decreases the overall carbon footprint associated with mattresses. But “all-natural” latex foam mattresses are more expensive to synthesize, as natural latex is limited to specific regions globally. Thus, an “all-natural” latex foam mattress may be too expensive for a mattress supplier to price affordably and remain competitive in the market with an acceptable profit margin. Conversely, latex foam may be produced via synthetic latex. This may decrease the price of a latex foam mattress but may be undesirable from a consumer viewpoint due to the higher carbon footprint. Polyurethane foam, on the other hand, is synthesized using petrochemicals, specifically polyols. Polyurethane foam mattresses are less expensive and are widely utilized by many mattress retailers. But polyurethane foam mattresses are considered of lesser or “cheaper” quality than other types of foam mattresses that do not provide the level of quality comfort desired by consumers.

A subset of higher quality foam mattresses includes memory foam mattresses. Memory foam (otherwise known as viscoelastic polyurethane) provides superior comfort and pressure relief and is denser compared to other polyurethane foams. Memory foam also molds to a person's body shape and thus offers excellent cushion. Memory foam mattresses, however, are not as supportive as latex foam mattresses. Moreover, a person sleeping on a memory foam mattress may experience a “sinking” effect over the duration of a rest period. This increases movement during sleep, as the person seeks to achieve a more comfortable position. Memory foam can thus require more effort to shift during sleep and cause greater disruption to one's sleep compared to a latex foam mattress. Furthermore, memory foam is known to absorb heat over time and soften as it gets warmer, thus exacerbating the “sinking” effect and may cause overheating during sleep.

When considering the main types of foam mattresses, there is a trade-off between sustainability, cost, performance, and feel. Polyurethane mattresses are the least expensive option but may not meet sustainability requirements and suffer from poor performance and feel. Memory foam, on the other hand, offers superior performance and feel compared to polyurethane foam, but is more expensive and potentially synthesized using petrochemicals. While latex foam can be synthesized using all natural, organic materials, the cost associated with making bedding material, including latex foam mattresses, may be prohibitively high for retailers to price latex foam bedding materials competitively and remain profitable. Furthermore, when substituting an organic or natural material into a bedding material, the bedding material often sacrifices feel and performance. Additionally, all foam mattresses emit a strong odor after fabrication, and the odor may last for days or weeks. This off-gassing effect is undesirable for consumer, as the chemical smell in surrounding living spaces can last for an extended period of time. There is thus an unmet need to make foam-based bedding material with more sustainable materials in an affordable manner, while maintaining highly desired performance and feel of the product and eliminating offensive odors associated with foam. The present disclosure provides methods for making a hemp fiber foam in an efficient, cost-effective manner that alleviates the existing problems in the bedding industry.

### SUMMARY

The embodiments provided herein disclose a method of making a hemp fiber foam and, more particularly, a method of making a hemp fiber foam bedding material.

In some embodiments, the present disclosure provides a method of producing a hemp fiber foam, the method comprising providing a mixture of foam reactants including an amount of hemp fiber that contains an amount of absorbed moisture, providing an amount of water to the mixture based on the amount of absorbed moisture within the amount of hemp fiber, reacting the mixture and pouring the mixture into a mold, and curing the mixture to form a hemp fiber foam wherein the amount of hemp fiber is incorporated into the hemp fiber foam. The foam reactants may include a polyol and an isocyanate, and the amount of hemp fiber may substitute for an equal amount of the polyol in the reaction of the mixture. The foam reactants may include latex, and the amount of hemp fiber may substitute for an equal amount of the latex in the reaction of the mixture. The amount of hemp fiber may be provided to the mixture ranging up to 25.0 weight percent. The amount of water provided to the mixture may be decreased in an amount ranging up to 2.5 weight percent. The amount of water provided to the mixture may be decreased by the amount of absorbed moisture within the amount of hemp fiber. The amount of hemp fiber may be in a powder form. The amount of hemp fiber may be an amount of hurd fiber. A curing time of the hemp fiber foam may be decreased compared to a curing time of a foam.

In some embodiments, the present disclosure provides a method of producing a hemp fiber foam bedding material, the method comprising providing a mixture of foam reactants including an amount of hemp fiber that contains an amount of absorbed moisture, providing an amount of water to the mixture based on the amount of absorbed moisture within the amount of hemp fiber, reacting the mixture and pouring the mixture into a mold, curing the mixture to form a hemp fiber foam wherein the amount of hemp fiber is incorporated into the hemp fiber foam, cutting the hemp fiber foam into at least one piece, and incorporating the at least one piece of the hemp fiber foam as a bedding material. The foam reactants may include a polyol and an isocyanate, and the amount of hemp fiber may substitute for an equal amount of the polyol in the reaction of the mixture. The foam reactants may include latex, and the amount of hemp fiber may substitute for an equal amount of the latex in the reaction of the mixture. The amount of hemp fiber may be provided to the mixture ranging up to 25.0 weight percent. The amount of water provided to the mixture may be decreased in an amount ranging up to 2.5 weight percent. The amount of water provided to the mixture may be decreased by the amount of absorbed moisture within the amount of hemp fiber. The amount of hmep fiber may be in a powder form. The amount of hemp fiber may be an amount of hurd fiber. A curing time of the hemp fiber foam may be decreased compared to a curing time of a foam. The curing time of the hemp fiber foam may be shorter than three days. The bedding material may be a mattress.

### BRIEF DESCRIPTION OF DRAWING(S)

Further features and advantages of the disclosure can be ascertained from the following detailed description that is provided in connection with the drawings described below:

FIG. 1 is a cross-sectional view of an example hemp fiber, consistent with embodiments of the present disclosure.

### DETAILED DESCRIPTION

The present disclosure relates to methods that may be used to make hemp fiber foams and hemp fiber foam bedding materials with high performance, desirable feel, and less usage of petrochemicals.

Foam-based bedding materials have become ubiquitous in the bedding industry and are highly desired by consumers. Foams may be incorporated into mattresses, either comprising an entire mattress, or incorporated into an individual component of a mattress. For example, a foam may be used as the comfort layer, or the top section of a mattress, which may provide contouring and cushioning. A foam may be used as the transition layer, or an intermediate layer, which assists in wicking heat away from the comfort layer. Furthermore, a foam may be used as the core of the mattress, which is the largest and firmest layer of the mattress and provides additional support, bounce, and ventilation. Two types of foam materials commonly used for bedding materials are latex foam and memory foam. A latex foam mattress may provide an edge over a memory foam mattress in that latex foam can be produced with natural resources, whereas memory foam requires petrochemicals. There have been recent trends in the bedding industry to shift away from the dependence of petrochemicals and thus reduce the carbon footprint associated with making bedding materials. Moreover, the Mattress Recycling Council reports that more than 50,000 mattresses are discarded in the United States every day (see, e.g., Mattress Recycling Council, Inc., Our Impact: Leading the Way, https://mattressrecyclingcouncil.org/our-impact/). So, a foam mattress that uses bio-degradable, organic, bio-based materials while maintaining a desirable performance and feel may be desired.

But when substituting an organic, bio-based material for a petrochemical in the fabrication of a foam mattress, or bedding material, performance and feel of the product are often diminished. For example, incorporating fiber materials such as cotton, wood, sawdust, or bamboo into a polyurethane foam (e.g., memory foam) mattress may sustain a desirable feel but sacrifice performance of the mattress. “Feel” may be understood to mean the firmness of the mattress, and “performance” may be understood to mean an action the mattress performs. Non-limiting examples of performance for a foam mattress may include wicking moisture or heat away from the body during sleep, maintaining an adequate airflow around the body during sleep, or contouring around the body to provide pressure-relief. Another option may be to forgo polyurethane foam mattresses and rely on a latex foam mattress. As described above, latex foam may be produced using organic materials and may be considered “all-natural.” An “all-natural” latex foam mattress, however, may be more expensive to make. Furthermore, an “all-natural” or synthetic latex foam mattress has a “bouncy” feel that may not provide the pressure relief that a memory foam mattress does. For at least these reasons, a latex foam mattress may not be as accessible to consumers compared to other polyurethane foam mattresses that rely on petroleum-derived chemicals to make.

For foam-based bedding materials, there is currently a heavy dependence on petroleum-derived materials. An unrealized goal in the bedding industry is to reduce the percentage of petrochemicals used in making a high performance and feel foam mattress that is affordably priced and sustainably produced. From a manufacturing perspective, it may be expensive to incorporate different materials into the foam fabrication process, and different materials may offset the desired traits of the end product, as described above. Furthermore, a prevalent and unavoidable issue with foam-based bedding materials is the significant amount of off-gassing from latex and polyurethane. The odor emitted may be offensive, cause significant discomfort to an individual, and permeate through an individual's residence. Current methods of the industry have not identified a cost-effective and sustainable solution to address these problems.

The present disclosure provides a method to create a foam-based bedding material while using fewer petrochemicals by substituting the petrochemicals with an organic, bio-based material. The foam-based bedding materials of the present disclosure exhibit excellent performance and feel, avoid emitted odor, and can be fabricated without an increase in cost or energy in the manufacturing process. Bedding materials may be understood to include mattresses, pillows, comforters, mattress pads, or any other textile made for sleeping. The foam-based bedding materials of the present disclosure may be incorporated into a mattress.

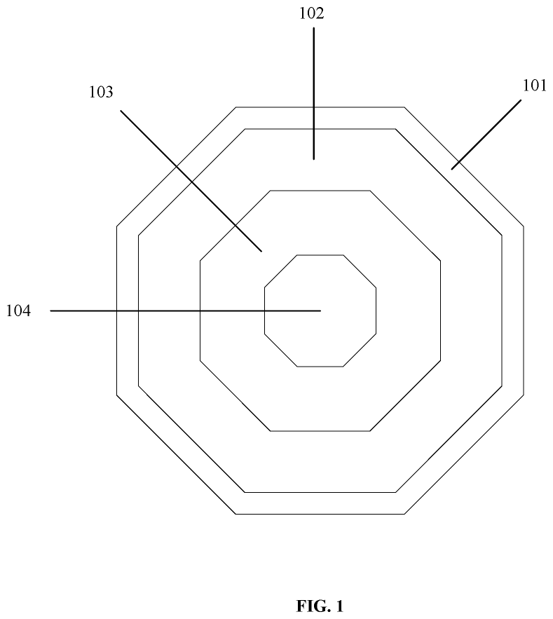

Embodiments of the present disclosure may include incorporating a hemp fiber into a foam. The hemp fiber may be ground to a fine powder and added to a formulation to create the foam. Hemp fiber is obtained from the hemp plant of the Cannabis species and is non-psychoactive. Hemp fiber consists of two types of fibers: bast and hurd. Reference is now made to FIG. 1, which is an example cross-section illustration of a cross-section of a hemp stalk. As seen in FIG. 1, the hemp stalk contains an outer layer 101 that is the epidermis, or bark, and a hollow core 104. The first inner layer 102 inside from outer layer 101 contains the bast fibers. The bast fibers are joined together by a middle lamella, mainly composed of pectin and arranged in bundles forming a ring around the outer part of the stalk. The second inner layer 103 contains the hurd fibers. Bast fibers are 10 to 100 times longer than the woody hurd fibers. The diameters of both types of fibers are equivalent, but the cell walls of the bast fibers are 5 to 10 times thicker than those of the hurd fibers. The hurd fibers are chemically similar to wood and are considered the least valuable part of the hemp stalk. The bast fibers are considered high quality fibers due to their strong cell walls and length. In some embodiments, the hemp hurd (e.g., second inner layer 103 in FIG. 1) is harvested, ground into a fine powder, and introduced to a formulation to synthesize a foam comprising hemp fiber. In some embodiments, the hemp fiber may be incorporated into a polyurethane foam. In some embodiments, the hemp fiber may be incorporated into a latex foam. Both a polyurethane foam and a latex foam may be formed by reacting a mixture of foam reactants and water. Foam reactants may include, but are not limited to, an isocyanate, an isocyanate-reactive component, latex, a surfactant, a hemp fiber, a gelling agent, a catalyst, a stabilizer, a foam promoter, and/or an additive.

A latex foam may be synthesized by mixing latex (e.g., synthetic or natural) with stabilizers, foam promoters, and other foam reactants. A foam may be produced by the Dunlop foam process or the Talalay foam process. It is appreciated that the term “latex” is known by those skilled in the art to mean an aqueous emulsion of natural or synthetic rubber or plastic (synthetic polymer) globules. Water forms the continuous phase of the emulsion, and natural or synthetic rubber or film-forming polymers form the discontinuous phase. Aqueous emulsions or solutions of film-forming natural or synthetic polymers (both homopolymers and copolymers) that may be useful in the present disclosure include, but are not limited to, styrene-butadiene latex, carboxylated styrene-butadiene latex, ethylene vinyl acetate latex, polyvinyl acetate latex, polyvinyl chloride latex, chloroprene latex, neoprene latex, silicone rubber dispersion, natural rubber latex, polyvinyl alcohol solution, polyvinyl alcohol solution stabilized with bromine, acrylic latex, styrene acrylic latex, vinyl acrylic latex, and compatible mixtures thereof. The amount of the aqueous emulsion of film-forming natural or synthetic polymers used in the formulation of the present disclosure depends on the type of application for which the foam will be used. Preferably, the amount of an aqueous emulsion of film-forming natural or synthetic polymers that may be useful in the present disclosure may be about 60% to about 99% by weight of the formulation; especially, about 15% to about 50% by weight of the formulation.

Briefly, for the Dunlop foam process, a batch of the latex mixture is rapidly foamed with a mixing apparatus at high speed after a period of maturing at room temperature. The mixing rate is adjusted to obtain a desired expansion of the foam and then stabilizing agents are added and the foam is transferred to a mold and allowed to cure. Additionally, the Dunlop foam process may be used to continuously synthesize latex foam. The latex mixture and air are metered into a base of a long vertical chamber and beaten to a foam. The foam flows continuously from the chamber down a chute into a second chamber, where a gelling agent and a stabilizing agent are metered into the foam. The foam passes through the two chambers and processed further via washing and cutting into blocks of foam.

For the Talalay process, mechanically mixed latex foam is expanded by applying vacuum to the mixture. The mixed latex foam is metered into a mold and fixed by a freeze-gel technique. The mold is heated by circulating fluids (e.g., poly-ethyleneglycol) to thaw and then vulcanize the foam. A denser latex foam may be produced via the Talalay process compared to the Dunlop process.

A polyurethane foam may be prepared using a reaction system that includes an isocyanate component and an isocyanate-reactive component. In particular, the polyurethane foam may be formed as the reaction product of the isocyanate component and the isocyanate-reactive component. The isocyanate component includes at least one isocyanate such as an isocyanate-terminated prepolymer and/or a polyisocyanate. The isocyanate-reactive component includes at least one compound having an isocyanate reactive hydrogen atom group, such as a hydroxyl group and/or an amine group. The isocyanate component and/or the isocyanate-reactive component may include an additive such as a catalyst, a hemp fiber, a curing agent, a surfactant, a blowing agent, a polyamine, and/or a filler.

According to some embodiments, the isocyanate-reactive component includes at least two components. In particular, the isocyanate-reactive component may include a polyol component and a hemp fiber.

The polyol component may account for 50.0 wt % to 99.8 wt % (e.g., 60.0 wt % to 99.8 wt %, 70.0 wt % to 99.5 wt %, 80.0 wt % to 99.0 wt %, 90.0 wt % to 99.0 wt %, etc., so as to be the majority component in the reaction system for forming the viscoelastic polyurethane foam) of the isocyanate-reactive component. The polyol component includes at least one polyether polyol and may optionally include at least one polyester polyol.

The additive component may include a catalyst, a hemp fiber, a curing agent, a surfactant, a blowing agent, a polyamine, water, and/or a filler. The additive component accounts for 0.1 wt % to 50.0 wt % (e.g., 0.1 wt % to 40.0 wt %, 0.1 wt % to 30.0 wt %, 0.1 wt % to 20.0 wt %, 0.1 wt % to 15.0 wt %, 0.1 wt % to 10.0 wt %, 0.1 wt % to 5.0 wt %, etc.) of the additive component, based on the total weight of the isocyanate-reactive component. The additive component in exemplary embodiments includes at least one catalyst and at least one surfactant.

In some embodiments, a hemp fiber is added to the foam formulation or mixture. The hemp fiber may be ground into a fine powder. In some embodiments, the hemp fiber may be present in the foam formulation or mixture in an amount ranging up to 25.0 wt %, based on the total weight of the formulation or mixture. In some embodiments, the hemp fiber may be present in the foam formulation or mixture in an amount of 2.5 wt %, 5.0 wt %, 7.5 wt %, 10.0 wt %, 12.5 wt %, 15.0 wt %, 17.5 wt %, 20.0 wt %, 22.5 wt %, or 25.0 wt %. In some embodiments, the hemp fiber may be present in the foam formulation or mixture in an amount ranging up to 2.5 wt %, 5.0 wt %, 7.5 wt. %, 10.0 wt %, 12.5 wt %, 15 wt %, 17.5 wt. %, 20.0 wt %, 22.5 wt %, or up to 25.0 wt. %. In some embodiments, the hemp fiber may be present in the foam formulation or mixture in an amount from 0 to 2.5 wt %, 2.5 to 5.0 wt %, 5.0 to 7.5 wt %, 7.5 to 10.0 wt %, 10.0 to 12.5 wt %, 12.5 to 15 wt %, 15 to 17.5 wt %, 17.5 wt % to 20.0 wt %, 20.0 to 22.5 wt %, or 22.5 to 25.0 wt %. In some embodiments, the hemp fiber may be present in the foam formulation or mixture in an amount from 2.5 to 5.0 wt %, 2.5 to 7.5 wt %, 2.5 to 10.0 wt %, 2.5 to 12.5 wt %, 2.5 to 15.0 wt %, 2.5 to 17.5 wt %, 2.5 to 20.0 wt %, 2.5 to 22.5 wt %, or 2.5 to 25.0 wt %. In some embodiments, the hemp fiber may be present in the foam formulation or mixture in an amount from 5.0 to 15.0 wt %. Each possibility represents a separate embodiment of the present disclosure. In some embodiments, the amount of hemp fiber may be substituted for an equal or substantially equal amount of the polyol component in the reaction to form a foam. In some embodiments, the amount of hemp fiber may be substituted for an equal or substantially equal amount of the latex component in the reaction to form a foam. It is appreciated that “substantially equal” may be an amount within a 10% deviation from the amount of the polyol component or the latex component.

The polyol component includes at least one polyether polyol and/or polyester polyol. Exemplary polyether polyols are the reaction product of alkylene oxides (such as at least one ethylene oxide, propylene oxide, and/or butylene oxide) with initiators containing from 2 to 8 active hydrogen atoms per molecule. Exemplary initiators include ethylene glycol, diethylene glycol, propylene glycol, dipropylene glycol, butane diol, glycerol, trimethylolpropane, triethanolamine, pentaerythritol, sorbitol, ethylene diamine, toluene diamine, diaminodiphenylmethane, polymethylene polyphenylene polyamines, ethanolamine, diethanolamine, and mixtures of such initiators. Exemplary polyols include VORANOL™ products, available from The Dow Chemical Company. The polyol component may include polyols that are useable to form viscoelastic polyurethane foams (e.g., memory foam).

For example, the polyol component may include a polyoxyethylene-polyoxypropylene polyether polyol that has an ethylene oxide content of at least 50 wt % (based on a total weight of the alkylene oxides used to form the polyol), that has a nominal hydroxyl functionality from 2 to 6 (e.g., 2 to 4), and has a number average molecular weight from 500 g/mol to 5000 g/mol (e.g., 500 g/mol to 4000 g/mol, from 600 g/mol to 3000 g/mol, 600 g/mol to 2000 g/mol, 700 g/mol to 1500 g/mol, and/or 800 g/mol to 1200 g/mol). The polyoxyethylene-polyoxypropylene polyether polyol that has an ethylene oxide content of at least 50 wt % may account for 5 wt % to 90 wt % (e.g., 10 wt % to 90 wt %, 25 wt % to 90 wt %, 25 wt % to 85 wt %, 35 wt % to 85 wt %, 45 wt % to 85 wt %, 50 wt % to 80 wt %, and/or 55 wt % to 70 wt %) of the isocyanate-reactive component. The polyoxyethylene-polyoxypropylene polyether polyol that has an ethylene oxide content of at least 50 wt % may be the majority component in the isocyanate-reactive component.

The polyol component may include a high molecular weight polyoxyethylene-polyoxypropylene polyether polyol that has an ethylene oxide content of at least 50 wt % (based on a total weight of the alkylene oxides used to form the polyol), that has a nominal hydroxyl functionality from 4 to 8 (e.g., 5 to 8), and has a number average molecular weight from 5,500 g/mol to 20,000 g/mol (e.g., 5,500 g/mol to 17,500 g/mol, from 5,500 g/mol to 15,500 g/mol, 5,500 g/mol to 14,500 g/mol, 6,500 g/mol to 14,500 g/mol, 8,500 g/mol to 14,500 g/mol, and/or 10,500 g/mol to 14,500 g/mol). The polyoxyethylene-polyoxypropylene polyether polyol that has an ethylene oxide content of at least 50 wt % may account for 5 wt % to 90 wt % (e.g., 5 wt % to 75 wt %, 5 wt % to 55 wt %, 5 wt % to 50 wt %, 5 wt % to 45 wt %, 5 wt % to 35 wt %, 5 wt % to 25 wt %, and/or 10 wt % to 20 wt %) of the isocyanate-reactive component. The high molecular weight polyoxyethylene-polyoxypropylene polyether polyol may be in addition to the relatively lower molecular weight polyoxyethylene-polyoxypropylene polyether polyol discussed above.

The polyol component may include a polyoxypropylene-polyoxyethylene polyether polyol that has an ethylene oxide content of less than 20 wt % (based on a total weight of the alkylene oxides used to form the polyol), that has a nominal hydroxyl functionality from 2 to 6 (e.g., 2 to 4), and has a number average molecular weight greater than 1000 g/mol (or greater than 1500 g/mol) and less than 6000 g/mol. For example, the molecular weight may be from 1500 g/mol to 5000 g/mol, 1600 g/mol to 5000 g/mol, 2000 g/mol to 4000 g/mol, and/or 2500 g/mol to 3500 g/mol. The polyoxypropylene-polyoxyethylene polyether polyol that has an ethylene oxide content of less than 20 wt % may account for 5 wt % to 90 wt % (e.g., 5 wt % to 70 wt %, 5 wt % to 50 wt %, 10 wt % to 40 wt %, and/or 10 wt % to 30 wt %) of the isocyanate reactive component. The polyoxypropylene-polyoxyethylene polyether polyol that has an ethylene oxide content of less than 20 wt % may be in a blend with the polyoxypropylene polyether polyol that has an ethylene oxide content of at least 50 wt %, whereas the latter of which is included in a greater amount.

The polyol component may include a polyoxypropylene polyether polyol that has a nominal hydroxyl functionality from 2 to 6 (e.g., 2 to 4) and has a number average molecular weight from 500 g/mol to 6000 g/mol (e.g., 500 g/mol to 5500 g/mol, from 600 g/mol to 5000 g/mol, 700 g/mol to 1500 g/mol, 800 g/mol to 1200 g/mol, 3000 g/mol to 6000 g/mol, 3000 g/mol to 5500 g/mol, 3500 g/mol to 5500 g/mol, and/or 4500 g/mol to 5500 g/mol). The polyoxypropylene polyether polyol may account for 5 wt % to 90 wt % (e.g., 5 wt % to 70 wt %, 5 wt % to 50 wt %, 10 wt % to 40 wt %, and/or 10 wt % to 30 wt %) of the isocyanate reactive component. The polyoxypropylene polyether polyol may be in a blend with the polyoxypropylene polyether polyol that has an ethylene oxide content of at least 50 wt %, whereas the latter of which is included in a greater amount.

In some embodiments, the polyol component may include a blend of the polyoxyethylene-polyoxypropylene polyether polyol that has an ethylene oxide content of at least 50 wt %, the polyoxyethylene-polyoxypropylene polyether polyol that has an ethylene oxide content of less than 20 wt %, and/or the polyoxypropylene polyether polyol. In other exemplary embodiments, the polyol component may include a blend of the polyoxyethylene-polyoxypropylene polyether polyol that has an ethylene oxide content of at least 50 wt %, the higher molecular weight polyoxyethylene-polyoxypropylene polyether polyol that has an ethylene oxide content of at least 50 wt %, the polyoxyethylene-polyoxypropylene polyether polyol that has an ethylene oxide content of less than 20 wt %, and/or the polyoxypropylene polyether polyol.

The additive component is separate from the components that form the preformed aqueous dispersion and/or the polyol component. The additive component is part of the isocyanate-reactive component, but other additives may be incorporated into the isocyanate component. The additive component may include a catalyst, a hemp fiber, a curing agent, a crosslinker, a surfactant, a blowing agent (aqueous and non-aqueous, separate from the aqueous polymer dispersion), a polyamine, a plasticizer, a fragrance, a pigment, an antioxidant, a UV stabilizer, water (separate from the aqueous polymer dispersion), and/or a filler. Other exemplary additives may include a chain extender, flame retardant, smoke suppressant, drying agent, talc, powder, mold release agent, rubber polymer (“gel”) particles, and other additives that are known in the art for use in foams and foam products.

The additive component may further include tin catalyst, zinc catalyst, bismuth catalyst, and/or amine catalyst. The total amount of catalyst in the isocyanate-reactive component may be from 0.1 wt % to 3.0 wt %.

A surfactant may be included in the additive component, e.g., to help stabilize the foam as it expands and cures. Examples of surfactants include nonionic surfactants and wetting agents such as those prepared by the sequential addition of propylene oxide and then ethylene oxide to propylene glycol, solid or liquid organosilicones, and polyethylene glycol ethers of long chain alcohols. Ionic surfactants such as tertiary amine or alkanolamine salts of long chain alkyl acid sulfate esters, alkyl sulfonic esters, and alkyl arylsulfonic acids may be used. For example, the formulation may include a surfactant such as an organosilicone surfactant. The total amount of an organosilicone surfactant in the isocyanate-reactive component may be from 0.1 wt % to 5.0 wt %, 0.1 wt % to 3.0 wt %, 0.1 wt % to 2.0 wt %, and/or 0.1 wt % to 1.0 wt %.

The formulation or mixture may include water, which is separate from the preformed aqueous polymer dispersion. The water may account for less than or equal to 2.0 wt % of the total weight of the formulation or mixture. The total water, including water from the preformed aqueous polymer dispersion and water added to the formulation or mixture, may account for less than or equal to 5.0 wt % of the total weight of the formulation or mixture. The total water, including water from the preformed aqueous polymer dispersion and water added to the formulation or mixture, may account for less than or equal to 1.0 wt % of the total weight of the formulation or mixture. The total water, including water from the preformed aqueous polymer dispersion and water added to the formulation or mixture, may account for less than or equal to 1.5 wt % of the total weight of the formulation or mixture. The total water, including water from the preformed aqueous polymer dispersion and water added to the formulation or mixture, may account for less than or equal to 2.5. wt % of the total weight of the formulation or mixture.

The isocyanate component includes at least one isocyanate. The isocyanate component is present at an isocyanate index from 50 to 150 (e.g., from 60 to 140, from 65 to 130, from 65 to 100, from 65 to 95, from 65 to 90, and/or from 65 to 85). The isocyanate index is defined as the molar stoichiometric excess of isocyanate moieties in a reaction mixture with respect to the number of moles of isocyanate-reactive units (active hydrogens available for reaction with the isocyanate moiety), multiplied by 100. An isocyanate index of 100 means that there is no stoichiometric excess, such that there is 1.0 mole of isocyanate groups per 1.0 mole of isocyanate-reactive groups, multiplied by 100.

The isocyanate component may include one or more isocyanate such as polyisocyanate and/or isocyanate-terminated prepolymer. The isocyanate may be isocyanate-containing reactants that are aliphatic, cycloaliphatic, alicyclic, arylaliphatic, and/or aromatic polyisocyanates or derivatives thereof. Exemplary derivatives include allophanate, biuret, and NCO (isocyanate moiety) terminated prepolymer. For example, the isocyanate component may include at least one aromatic isocyanate, e.g., at least one aromatic polyisocyanate or at least one isocyanate-terminated prepolymer derived from an aromatic polyisocyanate. The isocyanate component may include at least one isomer of toluene diisocyanate (TDI), crude TDI, at least one isomer of diphenyl methylene diisocyanate (MDI), crude MDI, and/or higher functional methylene polyphenyl polyisocyanate. Examples include TDI in the form of its 2,4 and 2,6-isomers and mixtures thereof and MDI in the form of its 2,4′-, 2,2′- and 4,4′-isomers and mixtures thereof. The mixtures of MDI and oligomers thereof may be crude or polymeric MDI and/or a known variant of MDI comprising urethane, allophanate, urea, biuret, carbodiimide, uretonimine and/or isocyanurate groups. Exemplary isocyanates include VORANATE™ 220 (a polymeric methylene diphenyl diisocyanate available from The Dow Chemical Company). Other exemplary polyisocyanate include tolylene diisocyanate (TDI), isophorone diisocyanate (IPDI) and xylene diisocyanates (XDI), and modifications thereof.

To form a hemp-fiber foam, the above-described formulation ingredients may be mixed with a hemp fiber (e.g., ground hemp fiber powder) using a mixing apparatus that has a mechanical mixing head, a trough for containing the foaming reaction, a conveyor for foam rise and cure, and a fall plate unit for leading expanding foam onto the moving conveyor.

In some embodiments, a hemp fiber foam that is synthesized as described above may have improved properties compared to polyurethane or latex foam. A hemp fiber foam may have no off-gassing or offensive odors that are apparent for polyurethane or latex foams. Hemp may eliminate the need for providing an additional odor-eliminating component to a foam, such as charcoal. In some embodiments, a hemp fiber may provide a flame-retardant effect to a foam when incorporated. Thus, a hemp fiber foam synthesized according to embodiments of the present disclosure may also eliminate a need of adding flame retardant components, such as plexiglass, to a foam.

### EXAMPLES

The following non-limiting examples are merely illustrative of embodiments of the present disclosure and are not to be construed as limiting the disclosure, the scope of which is defined by the appended claims. Parts are by weight percent of a total composition unless otherwise indicated.

Table 1 indicates physical property and performance results of a hemp fiber foam containing 10 parts per hundred hemp fiber (e.g., 10 wt %, replaced 10% of polyol in the formulation). The hemp fiber foam was synthesized with the relative weight amounts of each ingredient as described above. Once synthesized, the hemp fiber foam was cut into three blocks and each block was tested to determine properties of the foam including density, IFD, airflow, compression set, and recovery time.

The samples are tested to determine a density at 68° C. and 50% relative humidity in accordance with ASTM D3574, and a 25% indentation force deflection (IFD). The 25% IFD is defined as an amount of force in pounds required to indent a 50 in², round indenter foot into the sample a distance of 25% of the sample's thickness. Similarly, a 65% IFD is defined as the amount of force in pounds required to indent the indenter foot into the sample a distance of 65% of the sample's thickness.

The samples are also evaluated for compression set, in accordance with ASTM D3574. Static fatigue is a measure of a loss in load-bearing performance of the flexible polyurethane foam. Compression set is a measure of permanent partial loss of original height of the flexible polyurethane foam after compression due to a bending or collapse of cellular structures within the hemp-fiber foam. Compression set is measured by compressing the hemp-fiber foam by 90%, i.e., to 10% of original thickness, and holding the hemp-fiber foam under such compression at 70° C. for 22 hours. Compression set is expressed as a percentage of original compression.

Further, the samples are measured for porosity according to the air flow test of ASTM D2574. The air flow test measures the ease with which air passes through the hemp-fiber foams. The air flow test consists of placing a sample in a cavity over a chamber and creating a specified constant air-pressure differential. The air-flow value is the rate of air flow, in cubic feet per minute, required to maintain the constant air-pressure differential. Said differently, the air flow value is the volume of air per second at standard temperature and pressure required to maintain a constant air-pressure differential of 125 Pa across a 2″×2″×1″ sample.

The results are shown in Table 1, and it is clearly observed that each block demonstrated an undesirable compression set value. Specifically, a compression set value above 10 is considered a failing result for a bedding material. Each hemp fiber foam block in Table 1 exhibited a compression set 90% value of above 80. This means that when each block was compressed to 90% of its original thickness, each hemp-fiber foam lost above 80% of its height. Such results demonstrated in Table 1 are undesired for a foam in a bedding material.

TABLE 1
Physical property and performance of hemp fiber foam.

| | | | | | Uncrushed | Crushed | | | |
|---|---|---|---|---|---|---|---|---|---|
| | | IFD | IFD | | Dow Air | Dow Air | 90% | Recovery | |
| | Density | 25% | 65% | | flow | flow | Compression | Time | Tg |
| Sample | (pcf) | (lbf) | (lbf) | SAG | (SCFM) | (SCFM) | set (%) | (sec) | (° F.) |
| 1 | 2.42 | 3.83 | 9.15 | 2.39 | 5.54 | 5.58 | 80.07 | 12.2 | 73.19 |
| 2 | 2.47 | 4.09 | 8.56 | 2.09 | 4.4 | 4.79 | 83.48 | 11.08 | 75.61 |
| 3 | 2.45 | 3.93 | 9.23 | 2.35 | 5.14 | 5.54 | 82.56 | 9.58 | 74.09 |

The ground hemp fibers provided to the formulation or mixture, as described above and incorporated into the foams of Table 1, were found to contain an excess of water. Specifically, the hemp fibers were found to contain about 10% moisture on average, whereas the hemp powder incorporated into the foams synthesized in Table 1 was assumed to be dry and contain no moisture. Moisture impacts fiber structural integrity, and a high moisture content can lead to deterioration of fiber quality. According to the process described above to make a hemp fiber foam in Table 1, an excess of water was added since moisture content of the hemp was not considered. Thus, the hemp fiber foams in Table 1 had excess water, which may have caused the severe deterioration in material property and performance.

Table 2 indicates physical property and performance of a hemp fiber foam synthesized according to processes described above, but with an adjustment to the water content. Specifically, the amount of water metered into the barrel or mix head during processing was decreased, as moisture is already provided to the formulation via the ground hemp powder. The water content adjusted hemp fiber foam exhibits far superior material properties and performance compared to the foams of Table 1. Specifically, the water adjusted hemp fiber foam exhibits a 90% compression set value of 0.7, which is two orders of magnitude lower than the hemp fiber foam results demonstrated in Table 1. Foam-based bedding materials (e.g., memory foam or latex foam) exhibit a 90% compression set value ranging from 2 to 4. The 90% compression set results demonstrated in Table 2 are well below the industry standard and indicate that embodiments of the present disclosure may provide a hemp fiber foam material that outperforms existing foam bedding materials on the market. Moreover, embodiments of the present disclosure may provide a method to reduce the amount of water required to synthesize a foam or foam-based bedding material.

TABLE 2
Physical property and performance of water content adjusted hemp fiber foam.

| | | | | | Uncrushed | Crushed | | | |
|---|---|---|---|---|---|---|---|---|---|
| | | IFD | IFD | | Dow Air | Dow Air | 90% | Recovery | |
| | Density | 25% | 65% | | flow | flow | Compression | Time | Tg |
| Sample | (pcf) | (lbf) | (lbf) | SAG | (SCFM) | (SCFM) | set (%) | (sec) | (° F.) |
| 4 | 3.80 | 20.33 | 50.21 | 2.47 | 1.3 | 1.6 | 0.7 | 2.6 | 62.7 |

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The present disclosure may also be defined according to any one of the following numbered embodiments:

1. A method of producing a hemp fiber foam, the method comprising:
providing a mixture of foam reactants including an amount of hemp fiber wherein the amount of hemp fiber contains an amount of absorbed moisture;
providing an amount of water to the mixture based on the amount of absorbed moisture within the amount of hemp fiber;
reacting the mixture and pouring the mixture into a mold; and
curing the mixture to form a hemp fiber foam, wherein the amount of hemp fiber is incorporated into the hemp fiber foam.

2. The method of claim 1, wherein the foam reactants include a polyol and an isocyanate, and the amount of hemp fiber substitutes for an equal or substantially amount of the polyol in the reaction of the mixture.

3. The method of claim 1, wherein the foam reactants include latex, and the amount of hemp fiber substitutes for an equal or substantially amount of the latex in the reaction of the mixture.

4. The method of any one of embodiments 1 to 3, wherein the amount of hemp fiber provided to the mixture is 5.0 weight percent.

5. The method of embodiment 4, wherein the amount of water provided to the mixture is decreased by 0.5 weight percent.

6. The method of any one of embodiments 1 to 3, wherein the amount of hemp fiber provided to the mixture is 10.0 weight percent.

7. The method of embodiment 6, wherein the amount of water provided to the mixture is decreased by 1.0 weight percent.

8. The method of any one of embodiments 1 to 3, wherein the amount of hemp fiber provided to the mixture is 15.0 weight percent.

9. The method of embodiment 8, wherein the amount of water provided to the mixture is decreased by 1.5. weight percent.

10. The method of any one of embodiments 1 to 9, wherein the amount of water provided to the mixture is decreased by the amount of absorbed moisture within the amount of hemp fiber.

11. The method of any one of embodiments 1 to 10, wherein the amount of hemp fiber is in a powder form.

12. The method of any one of embodiments 1 to 11, wherein the amount of hemp fiber is a hurd fiber.

13. The method of any one of embodiments 1 to 12, wherein a curing time of the hemp fiber foam is decreased compared to a curing time of a foam.

14. A method of producing a hemp fiber foam bedding material, the method comprising:
providing a mixture of foam reactants including an amount of hemp fiber wherein the amount of hemp fiber contains an amount of absorbed moisture;
providing an amount of water to the mixture based on the amount of absorbed moisture within the amount of hemp fiber;
reacting the mixture and pouring the mixture into a mold;
curing the mixture to form a hemp fiber foam wherein the amount of hemp fiber is incorporated into the hemp fiber foam;
cutting the hemp fiber foam into at least one piece; and
incorporating the at least one piece of the hemp fiber foam as a bedding material.

15. The method of embodiment 14, wherein the foam reactants include a polyol and an isocyanate, and the amount of hemp fiber substitutes for an equal or substantially equal amount of the polyol in the reaction of the mixture.

16. The method of embodiment 15, wherein the foam reactants include latex, and the amount of hemp fiber substitutes for an equal or substantially equal amount of the latex in the reaction of the mixture.

17. The method of any one of embodiments 14 to 16, wherein the amount of hemp fiber provided to the mixture is 5.0 weight percent.

18. The method of embodiment 17, wherein the amount of water provided to the mixture is decreased by 0.5 weight percent.

19. The method of any one of embodiments 14 to 16, wherein the amount of hemp fiber provided to the mixture is 10.0 weight percent.

20. The method of embodiment 19, wherein the amount of water provided to the mixture is decreased by 1.0 weight percent.

21. The method of any one of embodiments 14 to 16, wherein the amount of hemp fiber provided to the mixture is 15.0 weight percent.

22. The method of embodiment 21, wherein the amount of water provided to the mixture is decreased by 1.5 weight percent.

23. The method of any one of embodiments 14 to 19, wherein the amount of water provided to the mixture is decreased by the amount of absorbed moisture within the amount of hemp fiber.

24. The method of any one of embodiments 14 to 23, wherein the amount of hemp fiber is in a powder form

25. The method of any one of embodiments 14 to 24, wherein the hemp fiber is a hurd fiber.

26. The method of any one of embodiments 14 to 25, wherein a curing time of the hemp fiber foam is decreased compared to a curing time of a foam.

27. The method of any one of embodiments 14 to 26, wherein the curing time of the hemp fiber foam is shorter than three days.

28. The method of any one of embodiments 14 to 27, wherein the bedding material is a mattress.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well (i.e., at least one of whatever the article modifies), unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The methods described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the method in addition to those shown and described herein will become apparent to those skilled in the art from the foregoing description. Such modifications are also intended to fall within the scope of the appended claims. Any patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the disclosure(s) set forth herein.

What is claimed is:

1. A method of producing a hemp fiber foam, the method comprising:
providing a mixture of foam reactants including an amount of hemp fiber wherein the amount of hemp fiber contains an amount of absorbed moisture;
providing an amount of water to the mixture based on the amount of absorbed moisture within the amount of hemp fiber;
reacting the mixture and pouring the mixture into a mold; and
curing the mixture to form a hemp fiber foam, wherein the amount of hemp fiber is incorporated into the hemp fiber foam.

2. The method of claim 1, wherein the foam reactants include a polyol and an isocyanate, and the amount of hemp fiber substitutes for an equal amount of the polyol in the reaction of the mixture.

3. The method of claim 1, wherein the foam reactants include latex, and the amount of hemp fiber substitutes for an equal amount of the latex in the reaction of the mixture.

4. The method of claim 1, wherein the amount of hemp fiber provided to the mixture ranges up to 25.0 weight percent.

5. The method of claim 4, wherein the amount of water provided to the mixture is decreased in an amount ranging up to 2.5 weight percent.

6. The method of claim 1, wherein the amount of water provided to the mixture is decreased by the amount of absorbed moisture within the amount of hemp fiber.

7. The method of claim 1, wherein the amount of hemp fiber is in a powder form.

8. The method of claim 1, wherein the amount of hemp fiber is an amount of hurd fiber.

9. The method of claim 1, wherein a curing time of the hemp fiber foam is decreased compared to a curing time of a foam.

10. A method of producing a hemp fiber foam bedding material, the method comprising:
providing a mixture of foam reactants including an amount of hemp fiber wherein the amount of hemp fiber contains an amount of absorbed moisture;
providing an amount of water to the mixture based on the amount of absorbed moisture within the amount of hemp fiber;
reacting the mixture and pouring the mixture into a mold;
curing the mixture to form a hemp fiber foam wherein the amount of hemp fiber is incorporated into the hemp fiber foam;
cutting the hemp fiber foam into at least one piece; and
incorporating the at least one piece of the hemp fiber foam as a bedding material.

11. The method of claim 10, wherein the foam reactants include a polyol and an isocyanate, and the amount of hemp fiber substitutes for an equal amount of the polyol in the reaction of the mixture.

12. The method of claim 10, wherein the foam reactants include latex, and the amount of hemp fiber substitutes for an equal amount of the latex in the reaction of the mixture.

13. The method of claim 10, wherein the amount of hemp fiber provided to the mixture ranges up to 25.0 weight percent.

14. The method of claim 13, wherein the amount of water provided to the mixture is decreased in an amount ranging up to 2.5 weight percent.

15. The method of claim 10, wherein the amount of water provided to the mixture is decreased by the amount of absorbed moisture within the amount of hemp fiber.

16. The method of claim 10, wherein the amount of hemp fiber is in a powder form

17. The method of claim 10, wherein the amount of hemp fiber is an amount of hurd fiber.

18. The method of claim 10, wherein a curing time of the hemp fiber foam is decreased compared to a curing time of a foam.

19. The method of claim 18, wherein the curing time of the hemp fiber foam is shorter than three days.

20. The method of claim 10, wherein the bedding material is a mattress.
